(19) United States
(12) Patent Application Publication
(10) Pub. No.: US 2012/0254060 A1
(43) Pub. Date: Oct. 4, 2012

(54) System, Method, And Computer Readable Medium for Ranking Products And Services Based On User Reviews

(75) Inventors: Alok Choudhary, Chicago, IL (US); Kunpeng Zhang, Evanston, IL (US); Ramanathan Narayanan, Jersey City, NJ (US)

(73) Assignee: NORTHWESTERN UNIVERSITY, Evanston, IL (US)

(21) Appl. No.: 13/438,421

(22) Filed: Apr. 3, 2012

Related U.S. Application Data
(60) Provisional application No. 61/471,529, filed on Apr. 4, 2011.

(51) Int. Cl. G06Q 30/00

(52) U.S. Cl. 705/347

(57) ABSTRACT

A method including obtaining a plurality of user reviews of different commercial products or services. The user reviews include statements about features of the products or services. The method also includes assigning a sentiment orientation to each of a plurality of the statements. The sentiment orientation indicates whether the statement reflects a positive sentiment or a negative sentiment. At least one of the features is a common feature that is shared by a plurality of the products or services. The method also includes ranking the products or services having the common feature relative to one another based on the sentiment orientations of the common feature.

### CROSS REFERENCE TO RELATED APPLICATIONS

The present application claims the benefit of U.S. Provisional Patent Application No. 61/471,529, filed on Apr. 4, 2011, which is incorporated by reference in its entirety.

### BACKGROUND

The subject matter described and/or illustrated herein relates generally to systems, methods, and computer readable media for ranking products or services and, more particularly, for analyzing user reviews, including user comments, on various social and digital media about the products or services to rank the products or services.

Increasingly large numbers of customers are choosing online shopping because of its convenience, reliability, and cost. As the number of products being sold online increases, it is becoming increasingly difficult for customers to make purchasing decisions based on the information provided. For example, product information (e.g., pictures, product descriptions, and the like) is typically provided by the manufacturer and, as such, can be biased to entice the consumer into purchasing the product. Traditionally, many customers have used expert rankings when making purchasing decisions. Expert rankings may be prepared by third parties having knowledgeable people dedicated to reviewing products or services in a certain industry or industries. For example, the website CNET.com publishes reviews of consumer electronics (e.g., digital cameras, phones, among other things) and the magazine Consumer Reports is dedicated to reviewing a variety of products. However, expert rankings can be inadequate in many ways. For example, expert rankings may be applicable only to a limited number of products and not the particular product of interest to the customer. Some rankings might contain individual preferences or opinions from the experts, which may not be objective or suitable in general. Expert rankings can also be outdated as new iterations or versions of the same product are released before the expert rankings are updated. Expert rankings are typically directed toward a small subset of products in a category. For example, an expert may review only a limited number of cameras (e.g., ten) in a category that has hundreds of cameras. Furthermore, expert rankings (as well as other ranking mechanisms) may only rank the products by overall quality. For example, expert rankings may assign a score for the overall quality, which is a score that indicates a quality of the product as a whole but does not separately indicate a quality of an individual feature(s) of the product. For customers interested in a particular feature, rankings of the overall quality may not be helpful.

On the other hand, user reviews—and particularly the text describing experiences or opinions of a particular product—may be more unbiased and provide a rich source of information to compare products and make purchasing decisions. Most major online retailers like Amazon.com, ebay.com, bestbuy.com, newegg.com, cnet.com, etc. allow customers to add user reviews of products they have purchased or otherwise experienced. Furthermore, users of a product may also provide reviews, comments, and feedback about the product on social media sites such as Facebook, Google+, Twitter. These user reviews have become a diverse and reliable source to aid other customers. However, some products may include hundreds or thousands of user reviews. A large number of user reviews can frustrate the potential customer, especially when the customer is only interested in a limited number of features or in a particular version of the product. Accordingly, there is a need for a method or a system that analyzes user reviews of different products or services to provide a ranking of the products or services.

### BRIEF DESCRIPTION

In one embodiment, a method (e.g., a commercial ranking method) is provided that includes obtaining plural user reviews of different products or services. The user reviews include statements that recite features of the products or services. At least one of the features is a common feature that is shared by two or more of the products or services. The method also includes assigning sentiment orientations to the statements that recite the common feature. The sentiment orientations indicate whether the statements to which the sentiment orientations are assigned reflect a positive sentiment or a negative sentiment. In some cases, the sentiment orientation may reflect an objective or neutral sentiment. The method also includes ranking the products or services that share the common feature relative to one another based on the sentiment orientations of the statements that recite the common feature.

In one or more embodiments, the method also includes identifying or classifying the statements to which the sentiment orientations are assigned as a comparative statement or a subjective statement. Comparative statements may be statements (e.g., sentences) which indirectly express opinions by performing a comparison between two or more products or services. Subjective statements may be statements which express directed praise or deprecation about a product or service.

In another embodiment, a commercial ranking system based on user reviews is provided. The system includes a mining module configured to obtain user reviews that relate to different products or services. The user reviews include statements that recite features of the products or services. At least one of the features is a common feature that is shared by a two or more of the products or services. The system also includes a sentiment module that is configured to assign sentiment orientations to the statements that recite the common feature. The sentiment orientations indicate whether the statements to which the sentiment orientations are assigned reflect a positive sentiment or a negative sentiment. The system also includes a ranking module that is configured to rank the products or services that share the common feature relative to one another based on the sentiment orientations of the statements that recite the common feature.

In a further embodiment, a non-transitory computer readable medium configured to rank commercial products or services is provided. The computer readable medium includes instructions to command a processor to obtain plural user reviews of different products or services. The user reviews include statements that recite features of the products or services. At least one of the features is a common feature that is shared by two or more of the products or services. The instructions also command the processor to assign sentiment orientations to the statements that recite the common feature. The sentiment orientations indicate whether the statements to which the sentiment orientations are assigned reflect a positive sentiment or a negative sentiment. The instructions also command the processor to rank the products or services that share the common feature relative to one another based on the sentiment orientations of the statements that recite the common feature.

### BRIEF DESCRIPTION OF THE DRAWINGS

FIG. 1 is a flowchart illustrating a method in accordance with one embodiment.

FIG. 2 shows an algorithm for identifying comparative statements from a plurality of written statements.

FIG. 3 shows an algorithm that may be used during sentiment orientation analysis of the written statements.

FIG. 4 shows a product graph generated according to one embodiment.

FIG. 5 shows a product graph that was generated using example data.

FIG. 6 illustrates an algorithm that summarizes a ranking methodology according to one embodiment.

FIG. 7 shows a table that ranks commercial products based on product features.

FIG. 8 is a schematic diagram of a system according to one embodiment.

### DETAILED DESCRIPTION

The following detailed description of certain embodiments will be better understood when read in conjunction with the appended drawings. To the extent that the Figures illustrate diagrams of functional blocks of various embodiments, the functional blocks are not necessarily indicative of the division between hardware. Thus, for example, one or more of the functional blocks may be implemented in a single piece of hardware or multiple pieces of hardware. It should be understood that the various embodiments are not limited to the arrangements and instrumentality shown in the drawings. Additionally, the system blocks in the various Figures or the steps of the methods may be rearranged or reconfigured.

As used herein, an element or step recited in the singular and proceeded with the word “a” or “an” should be understood as not excluding plural of said elements or steps, unless such exclusion is explicitly stated. Furthermore, references to “one embodiment,” “an exemplary embodiment,” “some embodiments” and the like are not intended to be interpreted as excluding the existence of additional embodiments that also incorporate the recited features. Moreover, unless explicitly stated to the contrary, embodiments “comprising” or “having” an element or a plurality of elements having a particular property may include additional such elements that do not have that property.

Embodiments described herein may analyze written statements regarding products and/or services (e.g., sentences from expert reviews or reviews from customers of the product or service) to provide a feature-based ranking of a plurality of products and/or services. As used herein, the term “product” includes any tangible good or commodity that may be offered for sale, and the term “service” includes any activity provided by another person(s) or entity (e.g., corporation) that may be offered for sale. A service may also be referred to as an intangible commodity. In many eases, the products and/or services are offered for sale on a website (e.g., Amazon.com) and/or a computer application (e.g., iTunes) that is capable of electronically receiving data and transmitting data through a communication network. The written statements may be directly associated with or connected to the product and/or service on the website or application. For example, the written statements may be located on the same webpage that includes the product and/or service, in a webpage that is directly linked to the webpage of the product and/or service, or in the website that includes the webpage of the product and/or service. However, in some embodiments, the written statements are not directly associated with or connected to the product and/or service on the website or application. For example, the written statement may be from a user review that is posted on a social networking service (e.g., Facebook).

As used herein, a “feature” includes an attribute of a product and/or service that may be of interest to potential customers of the product and/or service. A feature includes an identifiable quality about a product and/or service that can be used to distinguish between other product and/or services. For example, a feature of some digital cameras may be the capability of capturing subsequent images more quickly than others (e.g., four images per second). A feature of some restaurants may be a catering service that is offered by the restaurants. When the feature is popular, vendors may sell the product and/or service having the popular feature at a greater price than the prices of other products and/or services that do not have the popular feature. Even when the feature is not particularly popular, potential customers may be interested in comparing the different products having the desired feature. In one or more embodiments, a feature may also be a cost of the product or service or a cost range of the product or service.

Particular embodiments are directed toward product features and are configured to rank products based on one or more product features (e.g., based on an attribute that is of interest to potential customers of the product, or an “attribute-of-interest”). The term “product” is not intended to be limiting on any particular product described herein, and may include other products that are available or will be available for purchasing. Although many examples provided herein relate to digital cameras or televisions, embodiments are not limited to these types of products. In addition, other embodiments described herein may be directed toward service features and are configured to rank services based on one or more service features (e.g., based on an attribute-of-interest). For example, when the service includes dining at a restaurant, the attributes may be cleanliness, staff service, menu selection, particular meals, wine selection, etc. Other non-limiting examples of services include plumbing, car-washing, appliance repair, house cleaning, teaching, hairstyling, financial planning, and medical care.

As used herein, a “user review” of a product and/or service may include expert reviews written by those who have at least some expertise or knowledge that is relevant to the product category (e.g., veterans of an industry, avid product enthusiasts, ardent consumer advocates, and the like). Expert reviews are typically written by individuals that are contracted to provide the expert review. The term “user reviews” also can include non-expert reviews that are from customers of the product or service. However, in some embodiments, the rankings are primarily or entirely based on user reviews from non-experts. It should also be noted that at least some user reviews may be written by individuals that are not actually users of the product or service (e.g., “My friend says that this is the best SLR camera on the market”).

As used herein, a “user review” may include multiple written statements (e.g., textual expressions) that recite one or more features or may include only a single statement (e.g., “Best SLR camera on the market!”). A user review can also include an absolute valuation (e.g., “This camera is not worth the price”) or a relative valuation (e.g., “You can get a better camera for the same price” or “The Nikon D90 is a better camera for the price”). As used herein, a user review “recites” a feature if the user review includes a designated term that describes or identifies the feature (e.g., “resolution”) or another designated term that is part of a synonym set of the feature as described below.

As used herein, a “written statement” includes multiple terms that are grouped together to form a meaningful expression (e.g., sentences, clauses). Written statements not only include complete and grammatically correct sentences, but also include writings that may not satisfy conventional publishing standards. For example, online user reviews frequently include sentences that are not grammatically correct or are incomplete. User reviews may also include sentences with misspelled words, emoticons, slang, abbreviations, etc. Yet, these sentences may still provide useful information to the reader. Embodiments described herein may separate the written statements from a larger body of writing, such as a user review. The written statements may be separated from the user review based on punctuation such that the written statements are separate sentences, clauses, or other meaningful expressions of limited length.

As used herein, the meaning of “term” includes any word or identifiable phrase having a limited number of words (e.g., two to five words). Again, online user reviews may use terms that are not recognized by an established authority, but these terms may still convey meaning (e.g., valuation or sentiment of a product and/or service) to at least some readers. Thus, a term may be a word (including incorrect spellings of the word), a phrase, an abbreviation, or other symbol (e.g., emoticons) that conveys meaning to at least some readers. However, in some embodiments, terms that are analyzed may be limited to those that have an identifiable part-of-speech (POS). Additionally, the term may be obtained from a non-textual source. For example, terms used in one or more embodiments described herein may be obtained (e.g., manually or automatically transcribed) from videos and/or audio recordings of reviews of products or services. The recordings may be transcribed and uploaded into a system capable of analyzing the statements and terms as described below.

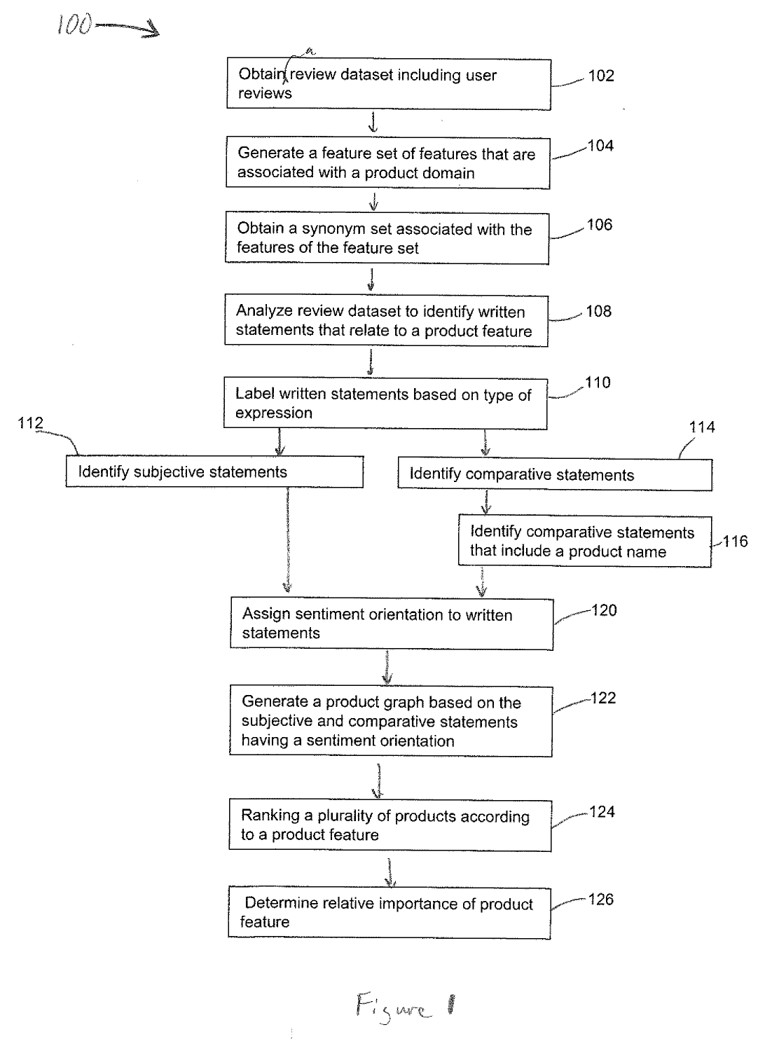

FIG. 1 is a flowchart illustrating a method 100 in accordance with one embodiment. The following is described with particular reference to products. Nonetheless, embodiments described herein may also be applicable to services. Accordingly, the term “product” in the following description may be substituted with “service” unless exclusion is explicitly stated. For example, the following describes a product domain having a number of product features. Likewise, embodiments of the present application may include a service domain having a number of service features. Furthermore, although the method 100 is shown and described as proceeding in one manner, embodiments may proceed in different manners in which some of the operations are performed in a different order or some of the operations are performed at least partially concurrently with others.

One or more embodiments described herein may rank a plurality of products according to a feature that is shared by the products, Rankings may assist a potential consumer in identifying a product that has a desired product feature among other products that shares the product feature. For example, rankings may indicate a relationship between one product and another product(s) based upon the shared product feature. The rankings may indicate an order of value of the products based on the product feature, Rankings may also include a list that is ordered from best to worst or worst to best. Rankings may assign to each product a numerical score or symbol based on a scoring system (e.g., number of stars) thereby indicating a value of the product feature.

By way of one example, digital cameras have numerous features that vary in importance to different customers. For example, digital cameras may be ranked on battery life, zoom range, weight of the camera, available user applications, quality of flash, focusing capabilities, type of lens, type of display, resolution, available memory, etc. Rankings may list those products that have the better zoom range or those products that have the better display as related by the customers through the user reviews. Although both rankings may list a plurality of products, the order of the products in the rankings may be different because the product features have different values based on the user reviews.

The method 100 may include obtaining at 102 a review dataset that includes a plurality of user reviews relating to products (or services). The review dataset may include user reviews generated by customers of a product and may also include expert reviews. Online retailers frequently allow a user of a product to provide a comment for other potential users to read. Hundreds or even thousands of reviews may be associated with some products. Thus, in some embodiments, the user reviews may be obtained through an online website(s) or an application programming interface (API) provided by an online retailer development department. A retailer that owns the online website(s) may store the user reviews for further analysis. Alternatively or additionally, an online video or audio file may include a review of a product or service and the video or audio file may be transcribed into a written review that is used in connection with one or more embodiments described herein.

In some embodiments, the obtaining at 102 includes actively collecting the user reviews. For example, the reviews may be obtained through crawling the Web and searching for one or more websites that include user reviews of products and/or services. For example, a computer program may search the Internet in a predetermined manner. The search may include a specific product name (e.g., “Canon EOS 7D” or “EOS 7D”) along with designated terms that are associated with a user review (“I like,” “best,” “worst,” “my opinion,” “IMHO”). The websites that are searched may include websites that are not solely dedicated to retail or product reviews, such as blogs by individuals. User reviews may also be obtained through the comments of individuals placed on social networking services (e.g., Facebook, Google+, Twitter). The above may be performed manually or may be performed automatically by a processor using an algorithm (e.g., one or more sets of instructions stored on a tangible and/or non-transitory computer readable storage medium, such as one or more software applications or modules stored on a computer hard drive or removable drive, that direct the processor to perform the collecting of the user reviews). Reviews are not required to be electronically available through a website, but may be, for example, derived from surveys that are manually taken with pen and paper by an individual. The surveys, including any comments by the individuals, may be input into a system (e.g., a computing device or other system that performs the operations of the method 100).

The obtaining operation 102 may also include receiving a previously-acquired review dataset from a database. The review dataset may be stored and maintained by one entity, and third parties may request and receive the review dataset from the entity. For example, a third party may operate a website that is dedicated to products of a certain type (e.g., consumer electronics, digital cameras, collectibles, etc.) and the third party may request and receive a review dataset from the entity. In some cases, the entity is the retailer that will provide the product and/or service if the customer decides to purchase the product and/or service.

The method 100 also includes generating or identifying at 104 a feature set that is associated with a product domain (or product category). A product domain includes products of a particular category. The product domain may be selected by the potential customer or determined by the retailer. A product domain typically includes a number of competing products. For example, if an individual is interested in purchasing a television, the product domain can encompass all available televisions. More specifically, the products in a product domain may satisfy the same purpose or function that is desired by the consumer. For example, products or services in the same domain may be interchangeable for a designated or desired functionality while providing different additional features or attributes. For instance, each television in a product domain of “Television” may be a system capable of displaying moving images. But if the product domain is “Three-Dimensional (3D) Televisions” then televisions that are not capable of displaying 3D are not part of the product domain.

However, product domains are not intended to be so abstract or broad such that the product domain is commercially unreasonable. For example, consumers who desire to purchase a digital camera having an LCD are not concerned with LCD televisions and would not wish to see a product ranking that included digital cameras with an LCD and LCD televisions. Consumers who desire to purchase a television are not concerned with smartphones, even if smartphones are capable of displaying moving images. Thus, embodiments are not configured to use abstract product domains in which the products have few common features that are desired by consumers.

Non-limiting examples of product domains that are commercially reasonable and not abstract include cell phones, camcorders, desktop computers, laptop computers, notebooks, tablets, smartphones, televisions, printers, dishwashers, refrigerators, clothes washers, clothes dryers, microwave ovens, vacuums, sedans, minivans, and trucks. Non-limiting examples of service domains include plumbers in a limited region (e.g., less than 20 miles), car-washing services in a limited region, appliance repair, house cleaners in a limited region, teaching in a limited region or remotely (e.g., through the Internet), hairstyling in a limited region, financial planning, and medical care in a limited region.

The generating operation 104 may include analyzing user reviews for terms that are frequently used within the reviews. For example, an algorithm may analyze the user reviews and count how many times different terms (e.g., unigram, bigram, or trigram) are used. The algorithm may eliminate terms that are unrelated to the product domain or generally any product domain. Many or all of the eliminated terms may be stop-words (or stop-terms) that are non-content bearing terms and/or terms with minimal lexical meaning. For example, stop terms may include “the,” “as,” “and,” “day,” “I,” “think,” “sunny,” “east coast.” The algorithm may also identify terms that exceed a designated threshold. The terms may also be limited to nouns or other words that are strongly associated with nouns (e.g., “weighs” is strongly associated with “weight”). In some embodiments, the analysis may be limited to expert reviews because expert reviews tend to be more focused on describing features that may be of interest to a consumer. Experts or salespersons in the field may be familiar with the features that consumers desire and, thus, can assist in generating the feature sets. The generating operation 104 may also include analyzing the product descriptions of products in the product domain. Product descriptions are typically provided by a manufacturer and can describe the product features that the manufactures believe would interest the potential customer, specifications of the products (e.g., quantifiable measurements of the products), and the like. For example, product features of digital cameras may include weight, processing power, memory size, battery life, and the like. In some cases, the product descriptions emphasize certain features but fail to describe others. For example, the product description for Product A may include descriptions of product features a, b, c, and d because the manufacturer believes product features a-d will entice a potential consumer to purchase product A. Yet the product description for Product B may emphasize product features c, d, e, and f because the manufacturer, which may or may not be the same manufacturer of product A, believes product features c-f will entice a potential consumer.

After analyzing a plurality of product descriptions and/or user reviews, a feature set may be established. The feature set may include at least a plurality of the product features identified through the analysis of the product descriptions and/or user reviews. The generating operation 104 may be performed automatically using an algorithm and/or include analysis by an individual. The individual may have some knowledge or expertise in a field related to the product domain or sales experience with products in the product domain.

In some embodiments, the product domain may be modified by the potential consumer to further limit the number of products in the product domain. For example, a user may desire only cameras that are less than a user-selected amount (e.g., financial cost) and that have at least a designated level of picture quality (e.g., number of pixels). The user-selected criteria can also affect the obtaining operation 102. For instance, a consumer may be provided a number of features (e.g., cost, battery life, weight) on a webpage of the retailer's website to select from. The consumer may provide certain conditions for each of the selected features. For example, the consumer may indicate that the cost must be less than $400, that the battery life must be at least five hours, and that a weight of the product must be less than three pounds. Having selected the criteria, the obtaining operation 102 may collect only user reviews of products that satisfy the criteria. Alternatively, the generating operation 104 may analyze only user reviews of products that satisfy the criteria.

At 106, a synonym set for the different product features may be obtained. A synonym set includes the different terms that are associated with the same or similar product feature. For example, the synonym set may include terms that have essentially the same meaning as the product feature or a strong association with the product feature. The synonym set may also include variations of those terms. The variations may include misspellings (e.g., pixel and pixie), abbreviations (e.g., megabytes and MB) or other types of shorthand, slang, jargon, or common spelling differences (e.g., color and colour). Synonym sets may include a species when the term is a genus or, in some cases, a genus when the term is a species. For instance, the synonym set for the product feature “lens” may include “wide-angle” and “telephoto.” Table 1 below provides examples of product features and respective synonym sets for the product domain of “digital camera” and the product domain of “television”.

TABLE 1

| Digital Camera | TV |
|---|---|
| resolution\|pixel\|megapixel | connection\|input\|output\| |
| | component video\|composite video\|HDMI |
| lens\|wide angle\|normal | adjustment\|stretch\|zoom\|expand\|compress |
| range | |
| optical\|zoom\|optical | film-mode\|frame\|theatrical\|3:2\|pull-down\| |
| zoom\|digital zoom | motion compensation\|CineMotion |
| memory\|megabytes\|MB | pip\|picture-in-picture\|dual-tuner\|pop\| |
| | picture-outside-picture\|two-tuner |
| burst\|continuous\|shutter\| | resolution\|1080p\|1080i\|720p |
| recovery\|motion\|sport | |
| battery\|batteries\|power | screen\|anti-glare\|reflectivity\|burn-in\| |
| | shiny\|screensaver\|pixel-shift |
| focus\|exposure\|manual\|iso | picture\|image\|picture quality\|image quality |
| LCD\|screen | sound\|sound quality\|speaker\|stereo\|audio |
| compression\|compress\|jpeg | size\|height\|width\|depth\|weight\|inch |
| flash\|light | remoter\|remote\|gear\|universal |

The obtaining operation 106 may include generating the synonym sets. For example, a processor may analyze user reviews and/or product descriptions to identify terms that may be included in a synonym set for a product feature. The obtaining operation 106 may also include generating a synonym set using an individual who has knowledge or expertise related to the product domain. The synonym set may be entirely created by the individual or the individual may assist a computing system in identifying synonymous terms. For example, the individual may review a list generated by the computing system and indicate those terms that should be grouped together in the same synonym set.

In some embodiments, the synonym sets are obtained from a database of previously-generated synonym sets. For example, a third party may request a synonym set that is tagged to or identified with a particular product domain. For example a third party may request a synonym set for the “digital camera” product domain and receive the synonym set that is shown in Table 1. If the domain requested by the third party is a sub-domain of a larger product domain, the synonym set for the larger product domain may be sent because the terms in the synonym set are likely relevant to the sub-domain. For instance, if the larger domain is “digital camera” and the requested product domain is “digital camera that costs more than $1000,” the terms in the synonym set of the larger domain are likely relevant to the requested product domain.

The method 100 also includes analyzing at 108 written statements of the user reviews to identify written statements that recite a product feature. Written statements that recite one or more product features may be referred to as “feature statements.” A feature statement may describe a product feature(s) of one or more products, include an opinion or sentiment about the product feature(s), praise or criticize a product feature(s), and/or compare (explicitly or implicitly) multiple products having a common feature(s). The user reviews that are analyzed at 108 may include the same user reviews that were analyzed to develop the feature set and the synonym set. Alternatively, the user reviews analyzed at 108 may include one or more different user reviews, or completely different user reviews, than what was analyzed to develop the feature set and the synonym set. The analyzing operation 108 may include keyword searching to identify written statements that recite a product feature. The keywords may be selected from the synonym sets of the product features. For example, if a written statement (e.g., a sentence) includes a term from the synonym set of a product feature, then the written statement may be somehow marked or labeled as including that product feature. A processor may store the written statement in a database or memory along with one or more flags that indicate the inclusion of the product feature in the written statement, in some cases, the same written statement may be tagged multiple times because the written statement has terms that are from different synonym sets. For example, the statement “The LCD and the lens are better in the NikonD90.” has two terms, “LCD” and “lens,” that are in different synonym sets. The terms may be in different synonym sets because the terms describe different features or attributes. The term “LCD” is not used to describe a lens and the term “lens” is not used to describe a liquid crystal display (LCD).

At 110, the written statements may be labeled based on a type of expression (also referred to as “expression type”) associated with the written statements. The labeling operation 110 may be limited to feature statements (e.g., written statements that have already been identified as including product features) or may be performed with written statements that have not been identified as feature statements. In other words, the labeling operation 110 may be performed before or concurrently with the analyzing operation 108. In particular embodiments, the labeling operation 110 includes identifying at 112 subjective statements. A subjective statement includes a statement that expresses praise or deprecation of a product (e.g., “This camera has excellent shutter speed.”). The labeling operation 110 may include identifying comparative statements. A comparative statement includes a statement that expresses an opinion or sentiment by including a comparison between features of two products (e.g., “I think the coolpix P300 has a wider aperture than the powershot 100.”). A subset of comparative statements includes product comparative statements (PCS). A PCS is a comparative statement that includes at least one product name (e.g., “This TV has much better sound quality when compared to the sony bravia.”). In the above example, “this TV” refers to the television that the user provided a user review about.

It should be noted that comparison statements may include explicit (or direct) comparisons (e.g., “I think the coolpix P300 has a better picture quality than the powershot 100.”). In the explicit comparison, two product names are provided. Comparison statements may also include implicit (or indirect) comparisons (e.g., “The Panasonic Lumix DMC-FZ150 has the best zoom of all the prosumer cameras!”). In this example, only one product name is provided, but the sentence refers to the zoom feature of all other consumer cameras.

As shown in the above examples, the subjective and comparative statements may generally relate to a product, but may also recite a product feature. In some embodiments, the labeling operation 110 may be executed after the feature statements are identified. In other embodiments, the labeling operation 110 may be performed concurrently with or immediately after the identification of a feature statement. For example, if a written statement is determined to be a feature statement, the feature statement may then be analyzed and labeled as a subjective or comparative statement. In alternative embodiments, the labeling operation 110 may occur before the feature statements are identified.

Comparative statements may be identified in various manners. As one example, the identifying operation 114 may include analyzing a written statement to determine if the written statement includes a comparative keyword from a designated set of comparative keywords (e.g., outperform, exceed, superior, prefer, choose, like, etc.).

Comparative statements may be identified at 114 by analyzing semantics of a written statement. Various rules may be applied in the analysis. For instance, if an adjective or an adverb in the written statement occurs in a comparative form (e.g., “heavier,” “clearer”, “smoother,” “quieter”), said adjective or adverb may be identified as providing a comparative meaning regarding two products (or product features). If an adjective or an adverb in the written statement is in a superlative form (e.g., “heaviest,” “clearest”, “smoothest,” “quietest”), said adjective or adverb provides a comparative relationship between one product (or product feature) and all other products (or product features) in the product domain.

The above semantic analysis may be performed by identifying the part-of-speech of at least some of the terms in a written statement. An algorithm may be executed to analyze the written statements and assign a POS tag to the terms. As an example, one algorithm is CRFTagger, which is a java-based conditional random field POS tagger for English. However, a modified algorithm or other algorithms may be used. Terms may be assigned POS tags of comparative adjective, comparative adverb, superlative adjective, and superlative adverb. Other POS tags may be used.

The identifying operation 114 may include analyzing the written statements to identify if the written statement includes one or more designated structural patterns that provide a comparison between or among product features. The designated structural patterns may include idiomatic phrases or combination of words used to provide comparisons (e.g., “as . . . as”; “the same as . . . ”; “as good as”; “similar to . . . ”; “just like”).

Each of the above analysis processes for identifying comparative statements may be used alone or in conjunction with others. Thus, the identifying operation 114 (or labeling operation 110) may include analyzing written statements to at least one of (a) identify written statements with designated keywords (e.g., designated terms); (b) identify written statements with terms having a designated POS; and (c) identify written statements having designated structural patterns. A processor may then store the written statements identified from (a), (b), and/or (c) in a database or memory along with one or more flags that indicate that the written statement is a comparative statement. In some embodiments, at least two of (a), (b), or (c) are performed and, in particular embodiments, each of (a), (b), and (c) is performed.

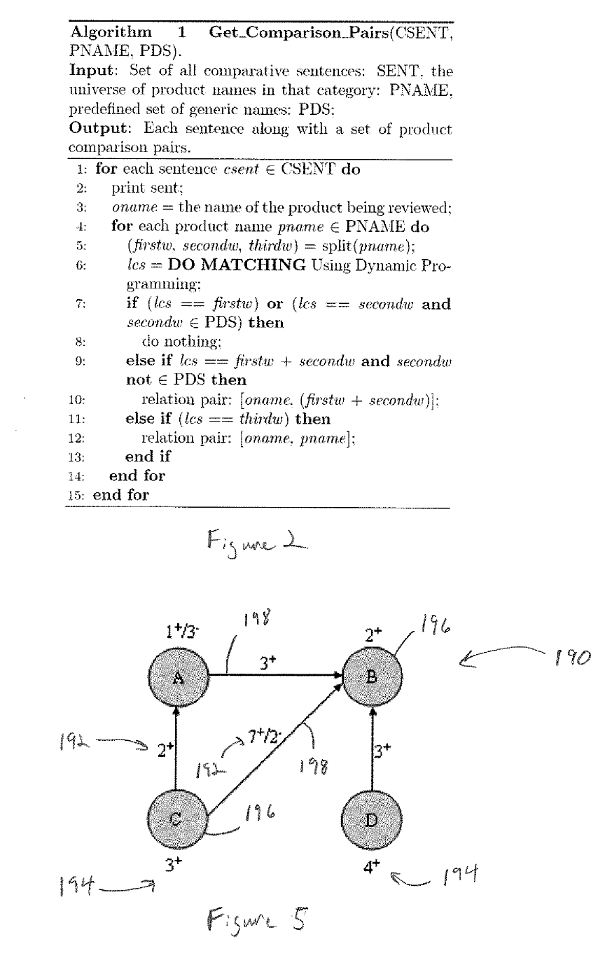

Optionally, the comparative statements that are identified in (a), (b), and/or (c) are further analyzed to determine if the comparative statements include at least one product name. Identifying at 116 comparative statements that include at least one product name may be accomplished in various ways. As one example, a dynamic programming technique (longest common subsequence) may be applied to the comparative statements. The comparative statements identified through the dynamic programming technique are the aforementioned PCSs, which are comparative statements that include at least one product name that is different from the product the written statement is describing. A PCS may be identified using a string matching algorithm. The string matching algorithm may compare terms in the written statements to a designated list of product names. As one example, given a product name and a match with a candidate, the string matching algorithm may apply the following rules: (1) if the candidate term only matches the first word of a product name, the match is ignored; (2) if the candidate term matches the first and second words of a product name then (a) the match is ignored if the second word is included in a predefined generic set or (b) the match is a successful match if the second word is not in a predefined generic set; and (3) if the candidate term matches the third word, the match is a successful match. The predefined generic set includes terms that are frequently used in the product name universe, such as “Power-shot” and “ThinkPad.” FIG. 2 shows an algorithm that may perform the above analysis. The comparative statements that include a successful match are determined to be PCSs.

However, the identifying operation 116 may be performed before the written statements are identified as comparative statements. More specifically, written statements may be analyzed to determine if the written statements include at least one product name as explained above. A processor may then store the written statements identified as including at least one product name in a database or memory along with one or more flags that indicate that the written statement includes at least one product name. The stored written statements may then be analyzed subsequently for product features or to determine if the written statement is a comparative statement described above.

The method 100 also includes assigning at 120 sentiment orientations to the written statements. In some embodiments, the assigning operation 120 is only performed with a select number of written statements. For example, after performing the operations 108 and 110, a filtered dataset may have written statements that recite at least one product feature and that are subjective statements or PCSs. However, in other embodiments, the assigning operation 120 may be performed concurrently with or before operations 108 and 110. More specifically, the written statements may be analyzed to assign a sentiment orientation whether or not the written statement includes at least one product feature or is a subjective or comparative statement. A processor may then store the written statements along with the corresponding sentiment orientations in a database or memory.

A sentiment orientation is a term that indicates whether a written statement includes a positive sentiment (or opinion), a neutral sentiment, or a negative sentiment. Various algorithms have been used for assigning a sentiment orientation to a term and databases of these terms have been created. Thus, in some embodiments, the written statements may be analyzed to identify designated terms that are associated with positive or negative sentiments. Each written statement including a positive term (e.g., good, great, best, quiet, smooth, clear, brilliant, awesome, beautiful, reliable, sturdy, fresh, happy, etc.) may be assigned a positive sentiment orientation and each written statement including a negative term (e.g., bad, worst, loud, rough, uneven, out-of-focus, frustrated, etc.) may be assigned a negative sentiment orientation. The terms may be individual words or phrases (e.g., high quality, low quality). By way of example, a positive word set and a negative word set were developed in the Multi-Perspective Question & Answering (MPQA) project. In some embodiments, written statements that have a neutral sentiment orientation are not considered in developing a product ranking. However, in alternative embodiments, neutral sentiment orientations may also be considered.

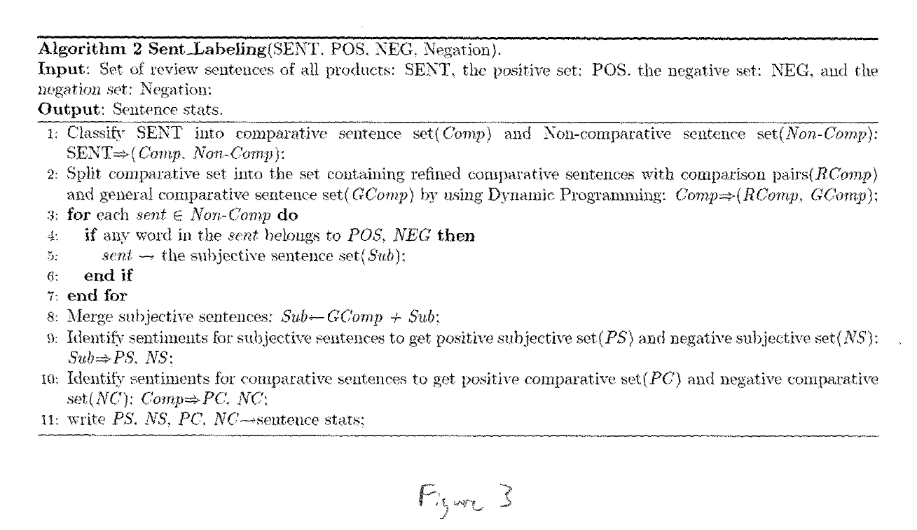

However, it should be noted that individuals often express opinions using negations or negative qualifiers. For example, “this is not a good camera” is a written statement that includes a term from the positive word set but also includes a term that negates the positive sentiment. Thus, in some embodiments, if a written statement includes a negation term, the sentiment orientation of the written statement may be switched from positive to negative or from negative to positive. FIG. 3 shows an algorithm that may perform the sentiment orientation analysis.

At 122, a product graph may be generated using the written statements and the assigned sentiment orientations. More specifically, the written statements that recite a product feature and at least one product and that have a sentiment orientation may be analyzed or processed to generate a product graph. A product graph G for a common feature f may be defined as follows:

G_{f}=(V,E)

where
V is a set of nodes, V={pᵢ|each node represents a product, 0<i<n},
E is a set of node pairs, called arcs or directed edges. An are e=(pᵢ, pⱼ) is considered to be directed from pᵢ to pⱼ. E={eₖ=(pᵢ, pⱼ),|Wₑ_{ᵢ} is the weight of the edge eᵢ, 0<i, j<n, 0<k<m}.
   where n is the number of products, m is the number of edges.

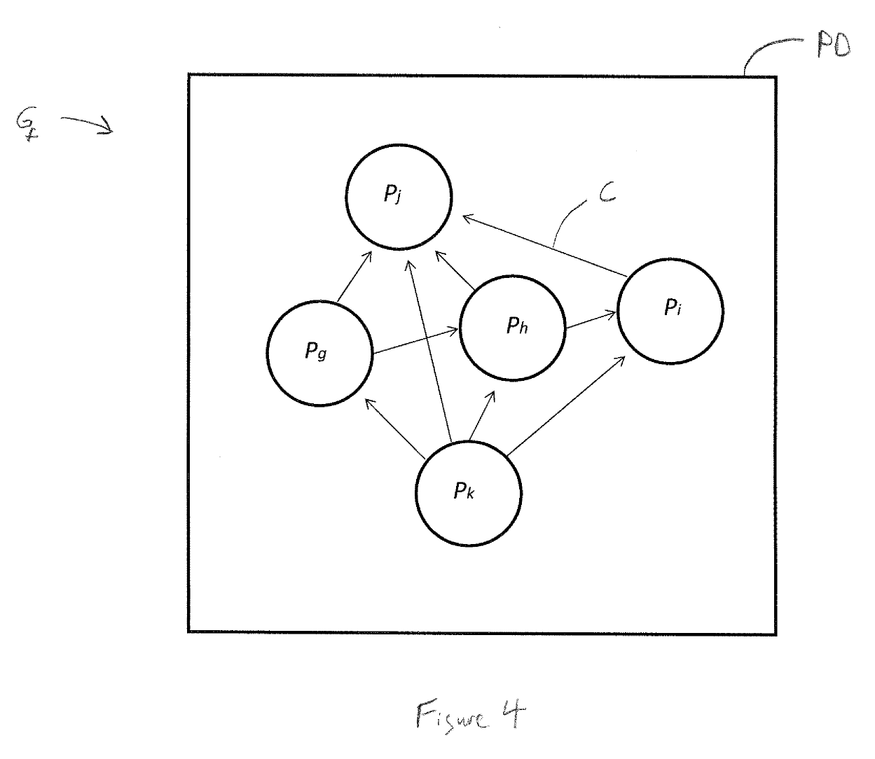

FIG. 4 illustrates the product graph G of the product feature f according to the equation above. The product graph G has nodes (indicated as circles), which represent products P_{g}, Pₕ, Pᵢ, Pⱼ, Pₖ, and directed edges (indicated as arrows), which represent comparisons C between the products P_{g}, Pₕ, Pᵢ, Pⱼ, Pₖ. The products P_{g}, Pₕ, Pᵢ, Pⱼ, Pₖ are all in the same product domain PD (indicated as a rectangle). As described above, user reviews of the products P_{g}, Pₕ, Pᵢ, Pⱼ, Pₖ in the product domain PD may include subjective and comparative written statements relating to the products P_{g}, Pₕ, Pᵢ, Pⱼ, Pₖ and that recite the product feature f as described above. If the written statement compares the product feature f of two products P, then a directed edge is drawn between the two products P. By way of example, if a comparative statement is identified between product Pᵢ and product Pⱼ (e.g., to compare the product feature f) a directed edge is drawn between Pⱼ and Pᵢ. If the comparative statement is located in the user reviews for product Pᵢ, and compares the product Pᵢ to product Pⱼ, then the direction of the edge (Pᵢ, Pⱼ) is from Pⱼ to Pᵢ.

The graph-generating operation 122 may include assigning an edge weight to the directed edge based on the number of positive comparative statements and negative comparative statements. A comparative statement occurring in the user reviews for product Pᵢ and comparing the product feature f to the product feature f of product Pⱼ may be considered a positive comparative (PC (Pᵢ; pⱼ)) if the comparative statement suggests that Pᵢ is better than Pⱼ. However, if the comparative statement suggests that Pᵢ is worse that Pⱼ, the comparative statement is considered a negative comparative (NC (Pᵢ; Pⱼ)). For each directed edge (Pⱼ, Pᵢ), a number of positive (PC) and negative (NC) comparative statements may be associated with the pair (Pᵢ, Pⱼ) A ratio PC=NC may be used as the edge weight of the directed edge that links Pⱼ and Pᵢ.

The nodes may also include node weights that represent an inherent quality of a product or product feature. As described above, a subjective statement expresses praise or deprecation of a product (e.g., “The picture quality of this television is excellent.”) without comparing the product to another product. The subjective statements may affect the node weight. For each product P, the node weight may be a ratio of positive subjective statements (PS) about the product feature f in the product P to negative subjective statements (NS) about the product feature f in the product P. The node weight of the node Pᵢ is based on the ratio PS/NS. If there are no negative subjective statements, meaning that NS is zero, then the ratio may be considered as (PS+1)/(NS+1)=PS+1.

The method 100 (FIG. 1) may also include ranking at 124 (FIG. 1) a plurality of products according to a product feature. The ranking operation 124 may be based on the product graph G described above. In some embodiments, the ranking operation 124 includes analyzing or processing the node weights and edge weights of the product graph in terms of the overall quality or in terms of a specific feature f. For example, the data generated by the product graph may be processed using the following equation that is entitled pRank:

```
    pRank(P) = [(1 − d) + d * Σₜ₌₁ⁿ 1_{{P}_{ᵢ}_{,P}} +
    pRank(Pᵢ) * C [symbol] (Pᵢ)] * C [symbol] (P), where
where
  pRank(P) is the product ranking of product P;
  pRank(Pᵢ) is the product ranking of product Pᵢ and
  n is the number of incoming links on product P;
  1_{{P}_{ᵢ}_{, P}} is an indicator function, s.t.
  ${1}_{( {P}_{i} , P )} = \{ \begin{matrix}1 & if there is a link from {P}_{i} to P \\ 0 & otherwise\end{matrix}$
  ${C}_{\text{?}} ( {P}_{i} ) = \frac{{W}_{\text{?}} ( {P}_{i} , P )}{{\sum }_{j = 1}^{\text{?}} {W}_{\text{?}} ( {P}_{i} , {P}_{j} )} , \\ \text{?} \text{indicates text missing or illegible when filed}$
  where m is the number
  of outbound links on product Pᵢ, Pⱼ are the nodes
  pointed to from Pᵢ and W (Pᵢ, Pⱼ) is the weight of
  the edge (Pᵢ, Pⱼ). It is the edge weight contributor
  to the ranking of product P;
  ${C}_{\text{?}} ( P ) = \frac{{W}_{\text{?}} ( P , P )}{{\sum }_{t = 1}^{\text{?}} {W}_{\text{?}} ( {P}_{t} , {P}_{t} )} . \\ \text{?} \text{indicates text missing or illegible when filed}$
  It is the node weight
  contributor to the ranking of product P.
```

[symbol]

indicates data missing or illegible when filed

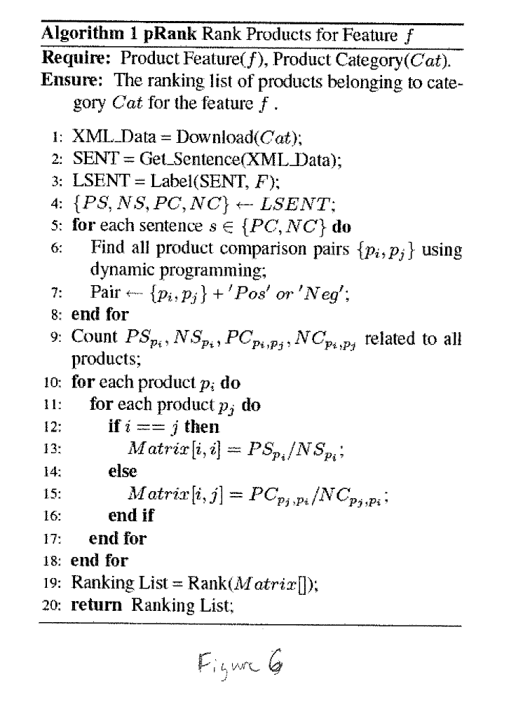

To illustrate the generating operation 122 and the ranking operation 124, FIG. 5 shows an example product graph 190 in which four products (A, B, C, D) are ranked according to a product feature f. The number of positive/negative, subjective/comparative statements with feature f are shown below:
PS_{f}(A)=1, PS_{f}(B)=2, PS_{f}(C)=3, PS_{f}(D)=4
NS_{f}(A)=3, PC_{f}(B,A)=3, PC_{f}(B,C)=7
PC_{f}(B,D)=3, PC_{f}(A,C)=2, NC_{f}(B,C)=2

FIG. 5 shows the product graph 190 as generated from the above statement statistics. The product graph 190 includes nodes 196 and edges 198. Edge weights 192 are determined by comparative statements, and node weights 194 are determined by subjective statements. As shown, since the user reviews of product C have 7 positive sentiment comparative statements mentioning product B (and feature f), and 2 negative sentiment comparative statements mentioning product B (and feature j), there is a directed edge 196 from product C to product B with weight 3.5. The directed edge 198 points from the relatively disfavored product (e.g., C) of the two products to the more favored product (e.g., B). The edge weights 192 between other products and the node weights 194 are also shown in FIG. 5, It must be mentioned that to prevent edges with infinite length, which may occur when the number of negative sentiment comparative sentences is 0, a minimum value of the denominator may be set to 1 while computing edge weights.

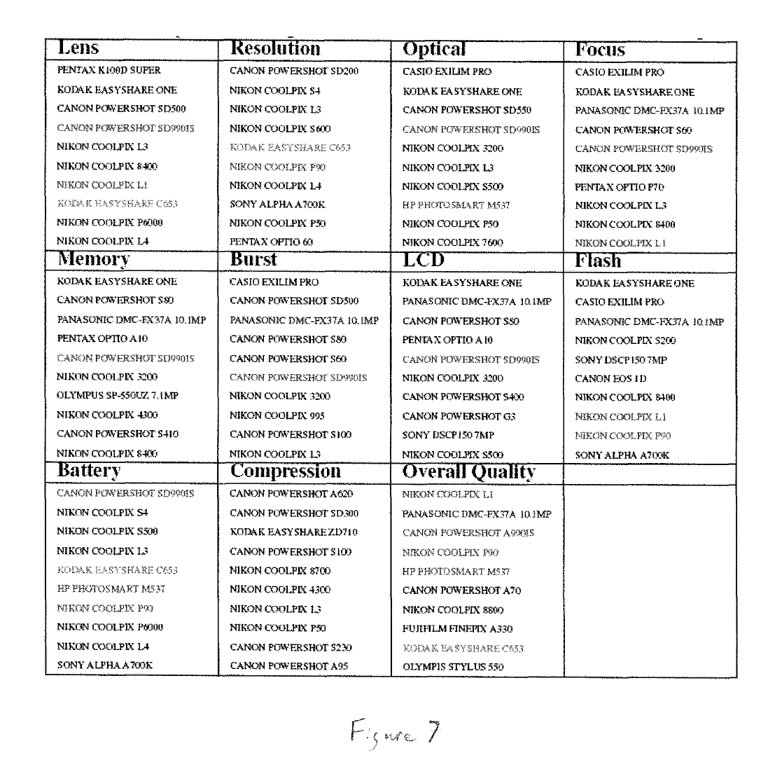

Using the above pRank equation, a ranking score for each product is determined as shown in the Table 2. The ranking order for the product graph 190 is product B being the most favored with respect to the product feature f, then product D, then product C, and then product A. As shown in FIG. 5, products A, C, and D are worse than product B because all of products A, C, and D have directed edges 198 pointing to B. Product D has more positive sentiment subjective statements than products A or C and the comparative edge weights of products A, C with product B are approximately equal (e.g., 3.5 to 3). Product C has a better ranking than product A because (i) two written statements suggest product A is better than product C and (ii) the user reviews for product A include 1 positive sentiment subjective statement and 3 negative sentiment subjective statements while user reviews for product C include 3 positive sentiment subjective statements. FIG. 6 illustrates the algorithm that uses the pRank equation to provide the feature-based ranking.

TABLE 2

| Rank | Vertex ID | Score |
|---|---|---|
| 1 | B | 0.820731 |
| 2 | D | 0.072917 |
| 3 | C | 0.053571 |
| 4 | A | 0.052781 |

As another example, an embodiment as described herein was used to analyze datasets that included user reviews of products from two different product domains, “Digital Camera” and “Television.” The dataset of the Digital Camera domain included 83005 user reviews for 1350 products, and the dataset of the Television domain included 24495 user reviews for 760 products. Table 3 shows relevant statistics obtained from the dataset of the Digital Camera domain, and Table 4 shows relevant statistics obtained from the dataset of the Television domain. The relevant statistics for the two datasets include: total number of sentences; frequency of occurrence of different product features; and number of subjective and comparative sentences and their sentiment orientations. To evaluate the ranking method described herein, product ranking was first performed based on the overall quality. The overall quality is based on various user opinions of the product as a whole and not with respect to particular features (even though the features of the product may affect a user's opinion of the product). To determine the overall quality of a product, comparative and subjective statements were identified from user reviews and were analyzed to generate a product graph Gₒᵥₑᵣₐₗₗ. In this case, the comparative and subjective statements were not further analyzed to identify feature statements. The product graph Gₒᵥₑᵣₐₗₗ was then analyzed and ranked using the ranking operation 124 described herein. To evaluate the effectiveness of the overall quality product ranking, the results were compared with a ranking performed by domain experts. The results indicate that the product ranking analysis achieves significant agreement with evaluations performed by subject experts with several years of experience and insight in their respective fields. More specifically, the digital cameras and televisions in the top 20% of expert rankings from SmartRatings.com overlapped with the digital cameras and televisions in the top 20% of the overall quality ranking produced from the product graph Gₒᵥₑᵣₐₗₗ. Approximately, an average overlapping probability of 62% was achieved for different price bins for cameras and televisions.

TABLE 3
Breakdown of Subjective/Comparative Sentences(Digital Camera)

| | Overall | | | | |
|---|---|---|---|---|---|
| | | No. of Subjective | | No. of Comparative | |
| | No. of | Sentences | | Sentences | |
| Feature | Sentences | Positive | Negative | Positive | Negative |
| Flash | 48378 | 10045 | 8202 | 1358 | 514 |
| Battery | 42461 | 4838 | 6439 | 1030 | 533 |
| Focus | 42393 | 7306 | 7241 | 1389 | 720 |
| Lens | 36371 | 4678 | 5313 | 1055 | 437 |
| Optical | 28658 | 3771 | 3196 | 842 | 338 |
| Lcd | 25874 | 4357 | 3587 | 755 | 216 |
| Resolution | 14992 | 1768 | 1647 | 579 | 227 |
| Burst | 14362 | 2925 | 2726 | 523 | 189 |
| Memory | 10794 | 1225 | 1652 | 365 | 143 |
| Compression | 1780 | 225 | 236 | 78 | 29 |
| Digital Camera | 1469940 | 71565 | 97349 | 16246 | 10890 |

TABLE 4
Breakdown of Subjective/Comparative Sentences(TV)

| | Overall | | | | |
|---|---|---|---|---|---|
| | | No. of Subjective | | No. of Comparative | |
| | No. of | Sentences | | Sentences | |
| Feature | Sentences | Positive | Negative | Positive | Negative |
| Sound | 13877 | 1599 | 1933 | 456 | 303 |
| Screen | 9021 | 1374 | 1457 | 501 | 344 |
| Size | 7214 | 492 | 516 | 342 | 214 |
| Connection | 6299 | 465 | 641 | 239 | 163 |
| Resolution | 6155 | 286 | 306 | 418 | 256 |
| Picture Quality | 4987 | 2847 | 1750 | 201 | 65 |
| Remoter | 4554 | 619 | 715 | 175 | 117 |
| Adjustment | 1704 | 170 | 215 | 74 | 48 |
| PIP | 1205 | 139 | 175 | 49 | 43 |
| Film-Mode | 1022 | 167 | 158 | 53 | 23 |
| TV | 460610 | 17843 | 28510 | 10224 | 9162 |

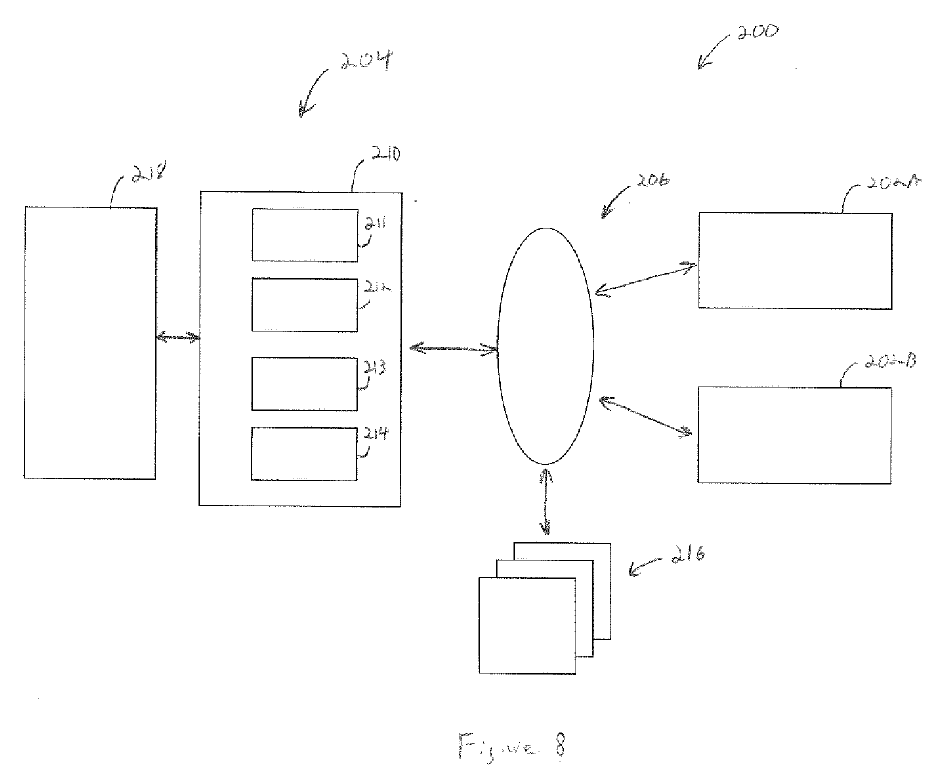

Individual product graphs were generated according to the ranking method described herein for the various features in the product domains of Digital Cameras and Televisions. The product graphs were analyzed and ranked according to the ranking operation 124. FIG. 7 shows different product rankings for ten different features from the Digital Camera domain. FIG. 7 also shows a Top 10 product ranking that is based on the overall quality of the cameras in the Digital Camera domain. As can be seen by comparing the Top 10 overall quality ranking to the feature-specific rankings, at least one digital camera from the Top 10 is in each feature-specific ranking, except for the feature-specific ranking of compression.

In some embodiments, a relative importance of a product feature may be determined at 126. For example, it may be desirable to a retailer or to a potential customer to identify the product features that customers (or other customers) are looking for when making purchasing decisions. The determining operation 126 may include two algorithms. The first algorithm determines a relative feature fraction RFF_{f} as shown below. The relative feature fraction RFF_{f} indicates how often one particular feature is recited in the statements of user reviews compared to how often other features are recited.

Definition 4.1.

$Relative Feature Fraction : {RFF}_{f} = \frac{{N}_{f}}{{\sum }_{f} {N}_{f}} * 100 \% , where {N}_{j} is the$
number of sentences labeled with feature f.

The second algorithm determines an importance of feature IF_{f} at 126. The importance of feature IF_{f} algorithm measures the agreement between the overall ranking and feature-specific ranking. The importance of a feature IF_{f} may also indicate the feature that makes the largest contribution to the overall quality.

Definition 4.2.

$Importance of Feature : {IF}_{f} = \frac{\vert X ⋂ {Y}_{f} \vert}{\vert X \vert} * 100 , where X = \{ top 10 \% of$
overall ranked products}, and Y_{f} = {top 10% of products according to
feature f}.

The above algorithms were used to evaluate the results of the ranking method described herein using the datasets from the Digital Camera and Television domains described above. Tables 5 and 6 are shown below and support the effectiveness of the ranking method. For example, the most frequently discussed features are the flash, battery, and focus features. As shown in FIG. 7, each of the feature-specific rankings for flash, battery, and focus includes at least three of the Top 10 cameras based on overall quality. The least mentioned camera feature shown in Table 5 and the least important feature shown in Table 6 for a digital camera is compression. As shown in FIG. 7, the only feature that does not include any of the Top 10 digital cameras is compression. As shown in Table 6, the most important feature of a digital camera is the lens. FIG. 7 shows that the feature-specific ranking for lens includes three of the Top 10 cameras based on overall quality. Accordingly, embodiments described herein may provide informative feature-specific rankings.

TABLE 5
The Relative Feature Fraction(RFF_{f}) for Digital Camera and TV

| Digital Camera | RFF_{f} | TV | RFF_{f} |
|---|---|---|---|
| Flash | 18.18% | Sound | 24.76% |
| Battery | 15.96% | Screen | 16.10% |
| Focus | 15.93% | Size | 12.87% |
| Lens | 13.67% | Connection | 11.24% |
| Optical | 10.77% | Resolution | 10.98% |
| LCD | 9.72% | Picture Quality | 8.90% |
| Resolution | 5.63% | Remoter | 8.13% |
| Burst | 5.40% | Adjustment | 3.04% |
| Memory | 4.06% | PIP | 2.15% |
| Compression | 0.67% | Film-Mode | 1.82% |

TABLE 6
Importance of Feature(IF_{f}) for Digital Camera and TV

| Digital Camera Features | IF_{f} | TV Features | IF_{f} |
|---|---|---|---|
| Lens | 79.9 | Size | 78.7 |
| Resolution | 79.8 | Film-Mode | 72.3 |
| Optical | 77.5 | Picture Quality | 70.7 |
| Focus | 76.3 | Connection | 69.1 |
| Memory | 76.3 | PIP | 69.1 |
| Burst | 75.2 | Sound | 67.5 |
| Lcd | 74.1 | Remoter | 67.5 |
| Flash | 72.9 | Adjustment | 64.3 |
| Battery | 71.6 | Screen | 61.2 |
| Compression | 68.4 | Resolution | 61.2 |

FIG. 8 illustrates a schematic diagram of a networking system 200 according on one embodiment. As shown, the system 200 includes a client system (or sub-system) that includes user devices 202A, 202B and a product ranking system (or sub-system) 204 that is communicatively coupled to the user devices 202A, 202B through a communication network 206. Non-limiting examples of the user devices 202A, 202B include a desktop computer, notebook, tablet, cell phone or other handheld device capable of communicating with the product ranking system 204 through the network 206. The user devices 202A, 202B are also capable of communicating information to a client-user (e.g., through a display). The product ranking system 204 is configured to rank products according to product features based on user reviews as described above with respect to the method 100 (FIG. 1). The product ranking system 204 may be owned, operated, or supported by a retailer or an entity contracted with a retailer. In other embodiments, the product ranking system 204 is operated by a website owner that is not associated with a particular retailer.

The product ranking system 204 includes a server system (or sub-system) 210 that includes one or more servers. A plurality of modules 211-214 may perform, at the server system 210, one or more of the operations that have been described with respect to the method 100. Each of the above modules 211-214 may include an algorithm (e.g. instructions stored on a tangible and/or non-transitory computer readable storage medium coupled to one or more servers) or sub-algorithms to perform particular processes. The product ranking system 204 may also include a database system 218 that stores data that may be used in a feature-based product ranking analysis. The database system 218 may include one or more databases and is configured to communicate with the server subsystem 210 and the modules 211-214.

The modules 211-214 may include a mining module 211 that is configured to obtain user reviews that are related to different commercial products (or services). The user reviews include written statements about features of the products. As described above, the user reviews may be obtained by crawling one or more websites 216 that include user reviews of a product. In some embodiments, the websites may sell or facilitate selling a variety of products in which at least some of the products have user reviews associated with them. Social networking platforms (e.g. Facebook, Google+, Twitter) also provide mechanisms to allow users to post their reviews. Accordingly, the mining module 211 may also obtain user reviews from websites of the social networking platforms.

The mining module 211 may be configured to analyze the user reviews and split the user reviews into separate written statements (e.g., sentences). For example, user reviews associated with a particular product on a webpage can be marked as being associated with the particular product. Each of the written statements separated from the user reviews of the webpage is identified as describing the particular product.

The product ranking system 204 may also include an analysis module 212. The analysis module 212 may be configured to perform one or more of operations 104, 106, 108, 110, 112, 114, 116, and 120 described above. For example, the analysis module 212 may analyze the written statements of the user reviews of products in a product domain to generate a feature set of the product domain. The analysis module 212 may also analyze the feature set(s) to generate corresponding synonym sets for each product feature. The analysis module 212 may solely perform the above operations or receive at least some assistance in the form of inputs or modifications from an individual.

The analysis module 212 may also be configured to analyze the written statements to identify the written statements that recite a product feature. Identification of such feature statements may be based on the synonym sets. In some embodiments, the analysis module 212 also analyzes the feature statements to label or categorize the feature statements based on expression type (e.g., subjective or comparative) as described above. The analysis module 212 can also analyze the comparative statements to identify if any comparative statements include a product name. Furthermore, the analysis module 212 may assign sentiment orientations to the written statements indicating whether the written statements reflect a positive sentiment, a negative sentiment or an objective or neutral sentiment. Accordingly, in some embodiments, the analysis module may be a sentiment module configured to analyze the statements and assign a sentiment orientation.

The product ranking system 204 also includes a graph-generation module 213 that is configured to generate a product graph based on the sentiment orientations of the written statements. The product graph may be used by a ranking module 214 of the product ranking system 204 to rank a plurality of products according to a common feature shared by the plurality of products.

The various modules 211-214 may communicate with each other and with the database system 218. The database system 218 may store data that is formatted for a particular purpose to be used by the modules 211-214. For example, the mining module 211 or the analysis module 212 may store written statements with the database system 218 that have been separated or parsed from the corresponding user reviews. Written statements from one user review may be tagged or labeled as being associated with a particular product. For example, if the user review was located on a webpage that offered to sell Product A (or at least provided information on Product A), then the written statements derived from the user review would be tagged or labeled as being associated with the Product A and stored with, for example, the database system 218. In other cases, if the written statement recites a product name(s), the written statement may be stored in the database system 218 as being associated with the named product(s).

In addition to the above, the database system 218 may store, for example, written statements that have been identified as reciting a feature, written statements that have been labeled as having an expression type (e.g., comparative, subjective), and written statements that have been assigned a sentiment orientation. The database system 218 may also store generated product graphs and product rankings (e.g., overall quality rankings or feature-specific rankings).

In some embodiments, a client-user may transmit, through the network 206, a ranking request from the user device 202A or 202B regarding a desired feature in a product category. The desired feature may be a physical attribute of the product, a capability of the product, or a cost/cost range of the product. The product ranking system 204 may receive the ranking request from the client-user at the server system 210. The server system 210 may generate a product ranking as described above that includes a list of products that include the desired feature. The list may indicate the products that have more positive sentiments than other products regarding the desired feature. The server system 210 is configured to supply the product ranking to the user through the network 206.

In some embodiments, the ranking request from the user device 202 may include a plurality of desired features. In such cases, a plurality of product rankings may be generated in which each product ranking relates to a different feature from the plurality of desired features. Each product ranking may be somehow communicated (e.g., displayed) to the client-user. For example, the product rankings may be simultaneously displayed (e.g., side-by-side). The display may, for example, be similar to the table shown in FIG. 7.

As described above, commercial features may be user-selected. Embodiments described herein may then analyze a plurality of user reviews and provide a product ranking to the customer. However, commercial features may also be identified by the server system 210. For example, after analyzing a plurality of reviews in a product category, a number of commercial features that are frequently described (positively or negatively) in the user reviews may be identified and then a product ranking that includes those commercial features may be presented to the client-user when the client-user visits a website. In other words, the product ranking may be generated without receiving a particular ranking request.

The various components and modules described herein may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer” or “module”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program, which may form part of a tangible, non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It should be noted that embodiments described herein do not require each and every operation to be performed in a method or by a processor or for each module to be included in a system. For instance, some methods may include (a) obtaining a review dataset, (b) labeling the written statements therein based on expression type, (c) analyzing the labeled statements to generate a product graph, (d) analyzing the product graph to provide a feature-based ranking. However, other methods may only include (a) receiving a dataset that includes labeled statements and (b) analyzing the labeled statements to generate a product graph.

Various aspects of the subject matter described herein are not directed solely to an abstract idea. For example, one or more embodiments described herein cannot reasonably be performed solely in the mind of a human being and may involve the use of tangible computational devices, such as computers, processors, controllers, and the like. At least one embodiment of a ranking method described herein could not reasonably be performed within the mind of a person and/or without use of a computational device (e.g., could not be performed merely with a pencil and paper). For example, it would be commercially unreasonable for a person to mentally analyze numerous user reviews of multiple products in a product domain to identify written statements that include a product feature, analyze those written statements to determine an expression type of the written statements (e.g., comparative or subjective), and then analyze those written statements to identify sentiment orientations. This is not commercially reasonable due to the relatively large number of user reviews that exist today for various products on numerous websites, and because the rate at which new, additional user reviews are added to the product domain may be such that the person either cannot complete the analysis or the resulting ranking or is less accurate and/or less complete (e.g., is based on fewer and/or older reviews) than one or more embodiments of the methods described herein. Instead, one or more embodiments described herein provide practical applications that allow a customer or entity to evaluate a plurality of products in a product domain based on one or more product features. One or more embodiments described herein may be performed autonomously by a processor (or controller or other-logic based device) in order to significantly improve the accuracy and/or speed of generating the rankings, and/or to greatly expand the information (e.g., reviews) used to generate the rankings relative to mentally performing the same tasks.

In accordance with another embodiment, a method is provided that includes obtaining plural user reviews of different products or services. The user reviews include statements that recite features of the products or services, wherein at least one of the features is a common feature that is shared by two or more of the products or services. The method also includes assigning sentiment orientations to the statements that recite the common feature. The sentiment orientations indicate whether the statements to which the sentiment orientations are assigned reflect a positive sentiment or a negative sentiment. The method also includes ranking the products or services that share the common feature relative to one another based on the sentiment orientations of the statements that recite the common feature.

In another aspect, one or more of the statements having the sentiment orientation are comparative statements that express a comparison between the common feature of a first product or service of the products or services and the common feature of a second product or service of the different products or services.

In another aspect, the comparative statements include at least one product name.

In another aspect, the comparative statements include at least one of (a) a designated comparative keyword; (b) a designated part-of-speech; and (c) a designated structural pattern.

In another aspect, the method may also include generating a product graph having nodes and edges that link corresponding nodes. The nodes represent the different products or services that share the common feature and the edges represent comparative statements that express a comparison between the common feature of two or more of the products or services, wherein ranking the products or services is performed based on the product graph.

In another aspect, the statements that are assigned the sentiment orientations include at least one of a subjective statement or a comparative statement that includes one product name. The subjective statement expresses praise or deprecation of the common feature of the product or service that corresponds to the subjective statement. The comparative statement expresses a comparison between the common feature of two or more of the products or services.

In another aspect, the features are product features relating to one or more designated attributes-of-interest of the products or services in a desired domain of the products or services.

In another embodiment, a commercial ranking system is provided that includes a mining module that is configured to obtain user reviews that relate to different products or services. The user reviews include statements that recite features of the products or services, wherein at least one of the features is a common feature that is shared by a two or more of the products or services. The system also includes a sentiment module configured to assign sentiment orientations to the statements that recite the common feature. The sentiment orientations indicate whether the statements to which the sentiment orientations are assigned reflect a positive sentiment or a negative sentiment. The system also includes a ranking module that is configured to rank the products or services that share the common feature relative to one another based on the sentiment orientations of the statements that recite the common feature.

In another aspect, one or more of the statements having the sentiment orientation are comparative statements that express a comparison between the common feature of a first product or service of the products or services and the common feature of a second product or service of the different products or services.

In another aspect, the comparative statements include at least one product name.

In another aspect, the comparative statements include at least one of (a) a designated comparative keyword; (b) a designated part-of-speech; and (c) a designated structural pattern.

In another aspect, the system also includes a graph-generation module that is configured to generate a product graph having nodes and edges that link corresponding nodes. The nodes represent the different products or services that share the common feature and the edges represent comparative statements that express a comparison between the common feature of two or more of the products or services, wherein ranking the products or services is performed based on the product graph.

In another aspect, the statements that are assigned the sentiment orientations include at least one of a subjective statement or a comparative statement that includes one product name. The subjective statement expresses praise or deprecation of the common feature of the product or service that corresponds to the subjective statement. The comparative statement expresses a comparison between the common feature of two or more of the products or services.

In another aspect, the mining module, the sentiment module, and the ranking module are part of a common server system.

In another embodiment, a non-transitory computer readable medium configured to rank products or services using a processor is provided. The computer readable medium includes instructions to command the processor to obtain plural user reviews of different products or services. The user reviews include statements that recite features of the products or services, wherein at least one of the features is a common feature that is shared by two or more of the products or services. The instructions also command the processor to assign sentiment orientations to the statements that recite the common feature. The sentiment orientations indicate whether the statements to which the sentiment orientations are assigned reflect a positive sentiment or a negative sentiment. The instructions also command the processor to rank the products or services that share the common feature relative to one another based on the sentiment orientations of the statements that recite the common feature.

In another aspect, one or more of the statements having the sentiment orientation are comparative statements that express a comparison between the common feature of a first product or service of the products or services and the common feature of a second product or service of the different products or services.

In another aspect, the comparative statements include at least one product name.

In another aspect, the comparative statements include at least one of (a) a designated comparative keyword; (b) a designated part-of-speech; and (c) a designated structural pattern.

In another aspect, the instructions also command the processor to generate a product graph having nodes and edges that link corresponding nodes. The nodes represent the different products or services that share the common feature and the edges represent comparative statements that express a comparison between the common feature of two or more of the products or services, wherein ranking the products or services is performed based on the product graph.

In another aspect, the statements that are assigned the sentiment orientations include at least one of a subjective statement or a comparative statement that includes one product name. The subjective statement expresses praise or deprecation of the common feature of the product or service that corresponds to the subjective statement. The comparative statement expresses a comparison between the common feature of two or more of the products or services.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter described herein without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A method comprising:
obtaining plural user reviews of different products or services, the user reviews including statements that recite features of the products or services, wherein at least one of the features is a common feature that is shared by two or more of the products or services;
assigning sentiment orientations to the statements that recite the common feature, the sentiment orientations indicating whether the statements to which the sentiment orientations are assigned reflect a positive sentiment or a negative sentiment; and
ranking the products or services that share the common feature relative to one another based on the sentiment orientations of the statements that recite the common feature.

2. The method of claim 1, wherein one or more of the statements having the sentiment orientation are comparative statements that express a comparison between the common feature of a first product or service of the products or services and the common feature of a second product or service of the different products or services.

3. The method of claim 2, wherein the comparative statements include at least one product name.

4. The method of claim 2, wherein the comparative statements include at least one of (a) a designated comparative keyword; (b) a designated part-of-speech; and (c) a designated structural pattern.

5. The method of claim 1, further comprising generating a product graph having nodes and edges that link corresponding nodes, the nodes representing the different products or services that share the common feature and the edges representing comparative statements that express a comparison between the common feature of two or more of the products or services, wherein ranking the products or services is performed based on the product graph.

6. The method of claim 1, wherein the statements that are assigned the sentiment orientations include at least one of a subjective statement or a comparative statement that includes one product name, the subjective statement expressing praise or deprecation of the common feature of the product or service that corresponds to the subjective statement, the comparative statement expressing a comparison between the common feature of two or more of the products or services.

7. The method of claim 1, wherein the features are product features relating to one or more designated attributes-of-interest of the products or services in a desired domain of the products or services.

8. A commercial ranking system comprising:
a mining module configured to obtain user reviews that relate to different products or services, the user reviews including statements that recite features of the products or services, wherein at least one of the features is a common feature that is shared by a two or more of the products or services;
a sentiment module configured to assign sentiment orientations to the statements that recite the common feature, the sentiment orientations indicating whether the statements to which the sentiment orientations are assigned reflect a positive sentiment or a negative sentiment; and
a ranking module configured to rank the products or services that share the common feature relative to one another based on the sentiment orientations of the statements that recite the common feature.

9. The system of claim 8, wherein one or more of the statements having the sentiment orientation are comparative statements that express a comparison between the common feature of a first product or service of the products or services and the common feature of a second product or service of the different products or services.

10. The system of claim 9, wherein the comparative statements include at least one product name.

11. The system of claim 9, wherein the comparative statements include at least one of (a) a designated comparative keyword; (b) a designated part-of-speech; and (c) a designated structural pattern.

12. The system of claim 8, further comprising graph-generation module configured to generate a product graph having nodes and edges that link corresponding nodes, the nodes representing the different products or services that share the common feature and the edges representing comparative statements that express a comparison between the common feature of two or more of the products or services, wherein ranking the products or services is performed based on the product graph.

13. The system of claim 8, wherein the statements that are assigned the sentiment orientations include at least one of a subjective statement or a comparative statement that includes one product name, the subjective statement expressing praise or deprecation of the common feature of the product or service that corresponds to the subjective statement, the comparative statement expressing a comparison between the common feature of two or more of the products or services.

14. The system of claim 8, wherein the mining module, sentiment module, and the ranking module are part of a common server system.

15. A non-transitory computer readable medium configured to rank products or services using a processor, the computer readable medium including instructions to command the processor to:
obtain plural user reviews of different products or services, the user reviews including statements that recite features of the products or services, wherein at least one of the features is a common feature that is shared by two or more of the products or services;
assign sentiment orientations to the statements that recite the common feature, the sentiment orientations indicating whether the statements to which the sentiment orientations are assigned reflect a positive sentiment or a negative sentiment; and
rank the products or services that share the common feature relative to one another based on the sentiment orientations of the statements that recite the common feature.

16. The computer readable medium of claim 15, wherein one or more of the statements having the sentiment orientation are comparative statements that express a comparison between the common feature of a first product or service of the products or services and the common feature of a second product or service of the different products or services.

17. The computer readable medium of claim 16, wherein the comparative statements include at least one product name.

18. The computer readable medium of claim 16, wherein the comparative statements include at least one of (a) a designated comparative keyword; (b) a designated part-of-speech; and (c) a designated structural pattern.

19. The computer readable medium of claim 15, further comprising instructions to command the processor to generate a product graph having nodes and edges that link corresponding nodes, the nodes representing the different products or services that share the common feature and the edges representing comparative statements that express a comparison between the common feature of two or more of the products or services, wherein ranking the products or services is performed based on the product graph.

20. The computer readable medium of claim 15, wherein the statements that are assigned the sentiment orientations include at least one of a subjective statement or a comparative statement that includes one product name, the subjective statement expressing praise or deprecation of the common feature of the product or service that corresponds to the subjective statement, the comparative statement expressing a comparison between the common feature of two or more of the products or services.
